(19) United States
(12) Patent Application Publication
(10) Pub. No.: US 2024/0199402 A1
(43) Pub. Date: Jun. 20, 2024

(54) DISPENSER INDICATION SYSTEM

(71) Applicant: Starbucks Corporation, Seattle, WA (US)

(72) Inventors: Joseph Emil Gormley, Mercer Island, WA (US); F Levi Danzer, Kent, WA (US)

(21) Appl. No.: 18/543,693

(22) Filed: Dec. 18, 2023

Related U.S. Application Data
(60) Provisional application No. 63/476,278, filed on Dec. 20, 2022.

(51) Int. Cl. B67D 1/10; B67D 1/08

(52) U.S. Cl. CPC B67D 1/102; B67D 1/0875; B67D 1/0888

(57) ABSTRACT

An indicator may include a body comprising a sensor and a recess configured to receive a pump head of a corresponding container. An indicator may include a light coupled to the body, wherein the light is configured to light up to indicate when a component in the corresponding container is part of a beverage order, and the sensor is configured to determine when a user dispenses an amount of the component into a beverage container. One or more indicators may communicate with a dock device to coordinate dispensing of beverage orders

### INCORPORATION BY REFERENCE TO ANY PRIORITY APPLICATIONS

This application claims priority to U.S. Provisional Patent Application No. 63/476,278, filed Dec. 20, 2022, the entirety of which is incorporated herein by reference.

### FIELD

The present disclosure relates to systems and method for indicating components in a beverage order, such as, in certain embodiments, systems and methods for receiving a beverage order and indicating to a user via one or more indicators components in the beverage order and/or amounts of the components in the beverage order.

### BACKGROUND

Customized beverages can be created by adding different quantities of sauces, syrups, and flavors to a base beverage, such as coffee or tea. Sauces, syrups and flavors are currently dispensed using disposable mechanical pumps or reusable mechanical pumps. The sauce, syrup or flavor is filled in the pump container. A barista pumps the sauce, syrup or flavor by manually pushing down on the pump levers to dispense fixed volumes of sauces, syrups and flavors thru the pump nozzles.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In some embodiments, a beverage component indicator can include: a body including a sensor and a recess configured to receive a pump head of a corresponding container; and a light coupled to the body, wherein the light is configured to light up to indicate when a component in the corresponding container is part of a beverage order, and the sensor is configured to determine when a user dispenses an amount of the component into a beverage container.

In some embodiments, the light can be configured to turn off when the sensor determines the amount of the component the user dispenses is an amount of the component in the beverage order.

In some embodiments, the light can be configured to indicate when to dispense the component into the beverage container.

In some embodiments, the light can be configured to indicate the amount of the component in the beverage order.

In some embodiments, the beverage component indicator can include a controller configured to send information to the sensor and the light, and the controller is configured to receive information from the sensor and the light.

In some embodiments, the sensor can be a capacitance sensor.

In some embodiments, the body can include a power source, and the light is configured to indicate if a power level of the power source is below a threshold.

In some embodiments, a system for indicating components of a beverage order can include: a plurality of indicators, each of the plurality of indicators including: a body including, a communication module, a sensor, and a recess configured to receive a pump head of a corresponding container; and a light coupled to the body, wherein the light is configured to light up to indicate when a component in the corresponding container is part of a beverage order, and the sensor is configured to determine when a user dispenses an amount of the component into a beverage container; a dock device including: a body including a control system; and a dock configured to receive the plurality of indicators; wherein the control system is configured to transmit information to the communication module of each of the plurality of indicators, and each of the indicators are configured to light up the light of each of the indicators based on the information.

In some embodiments, the indicators can include a power source, and the dock of the dock device can include an indicator connector configured to supply power to the power source of each of the indicators.

In some embodiments, the dock device can include a communication module configured to communicate with a point of sale system.

In some embodiments, the communication module can be configured to receive beverage orders from the point of sale system.

In some embodiments, the dock device can include an input device configured to receive a beverage order.

In some embodiments, the information can be based on a beverage order.

In some embodiments, a method of dispensing a beverage can include: receiving, by a dock device, a beverage order including one or more components; transmitting, by the dock device, information regarding the beverage order to one or more indicators; receiving, by each of the one or more indicators, the information; based on the received information, each of the one or more indicators, turning on a light of each of the one or more indicators if a component of a container paired with the indicator is part of a beverage order; dispensing, by a user, an amount of a first component of the beverage order; determining, by a sensor of a first indicator, the amount of the first component dispensed by the user, wherein the first indicator is an indicator paired to a container of the first component; and turning off, by the first indicator, the light of the first indicator paired with the container of the first component when the amount of the first component dispensed by the user.

In some embodiments, the method can include: dispensing, by the user, an amount of a second component of the beverage order; determining, by a sensor of a second indicator, the amount of the second component dispensed by the user, wherein the second indicator is an indicator paired to a container of the second component; and turning off, by the first indicator, the light of the first indicator paired with the container of the first component when the amount of the first component dispensed by the user.

In some embodiments, the lights of the one or more indicators can be configured to indicate an order to dispense the one or more components of the beverage order.

In some embodiments, each container can be paired with each indicator by scanning identifiable information of each container and identifiable information of each indicator.

In some embodiments, the sensor of the first indicator can detect a pressure applied to a pump head of the container to determine the amount of the first component dispensed by the user.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A illustrates an embodiment of an indicator of an indication system.

FIG. 1B illustrates an embodiment of the indicator of FIG. 1A coupled to a container.

FIG. 1C schematically illustrates a control system of an embodiment of an indicator of an indication system.

FIG. 2 illustrates an embodiment of a dock device of an indication system.

FIG. 3 illustrates an embodiment of an indication system.

FIG. 4 schematically illustrates a method of using an indication system.

### DETAILED DESCRIPTION

Coffee or tea beverages usually have a base of coffee or tea extracts mixed with dairy enhanced by a variety of textures, tastes, flavors, colors and/or aromas. One can create different textures, tastes, flavors, colors and aromas by adding different quantities of ingredients or modifiers (e.g., sauces, syrups and flavors) or adding the same ingredients or modifiers in different sequences. For example, to create a menu offering of 70 handcrafted coffee beverages, there may be 10 flavors, 2 syrups and 7 sauces. Flavors are usually alcohol based. Examples of some flavors are vanilla, toffee nut, and hazelnut. Sauces are usually multiple ingredients blended together in a water solution. Examples of some sauces are white chocolate mocha, chai and mocha. Syrups are usually liquid forms of sugar or sugar-free substitutes.

A recipe for a creamy coffee beverage could be to dispense hot espresso coffee extract into a cup, followed by two pumps of vanilla syrup, followed by a pump of white chocolate mocha sauce, followed by a fixed volume of steamed almond milk and finished with two pumps of toffee nut flavor. The recipe for a non-creamy beverage could be the same ingredients and quantities but dispensed in a different order (e.g., dispense a pump of white chocolate mocha sauce, followed by two pumps of vanilla syrup, followed by a fixed volume of steamed almond milk and followed with two pumps of toffee nut flavor and finished by dispensing a hot espresso coffee extract on top). Different beverages are made not only by varying the type and quantities of ingredients or modifiers (e.g., sauces, syrups and flavors), but also by changing the order in which they are added to the beverage.

A coffee store may offer a menu with 80-100 hand-crafted beverages. This means that each barista must memorize the recipes for each of the 80-100 beverages, including the ingredients or modifiers (e.g., sauces, syrups and flavors) in each beverage, the number of pumps, shots or doses, and the order in which the ingredients or modifiers are added. This creates a lot of complexity and memorization effort, which creates a challenge to expansion of the size and variety of the menu (e.g., variety of beverages).

Customers like to adjust the amount of ingredients, modifiers, or enhancers (e.g., sauce, syrup, and flavor) in their beverages to suit their individual taste and health needs. For example, a customer may want half the sugar and twice the amount of vanilla flavor of the normal recipe for a particular beverage. Baristas may want to simplify the mental efforts required in the beverage preparation process to increase throughput of beverage or a rate at which beverages, particularly complex beverages, may be made while maintaining the handmade service of a barista.

In accordance with several embodiments, the systems described herein advantageously indicate to a barista ingredients, modifiers or enhancers (e.g., sauces, syrups, flavors, tastes, colors, reductions) in a beverage order. The systems include indicators that may be paired to containers including ingredients, modifiers or enhancers. The indicators may indicate to the barista which ingredients, modifiers or enhancers are in a beverage order, an order to dispense or add ingredients, modifiers or enhancers to the beverage, and/or an amount of each of the ingredients, modifiers or enhancers to dispense or add to the beverage. In some embodiments, the systems include a dock device configured to receive orders, supply power to indicators, and/or orchestrate or control each of the indicators.

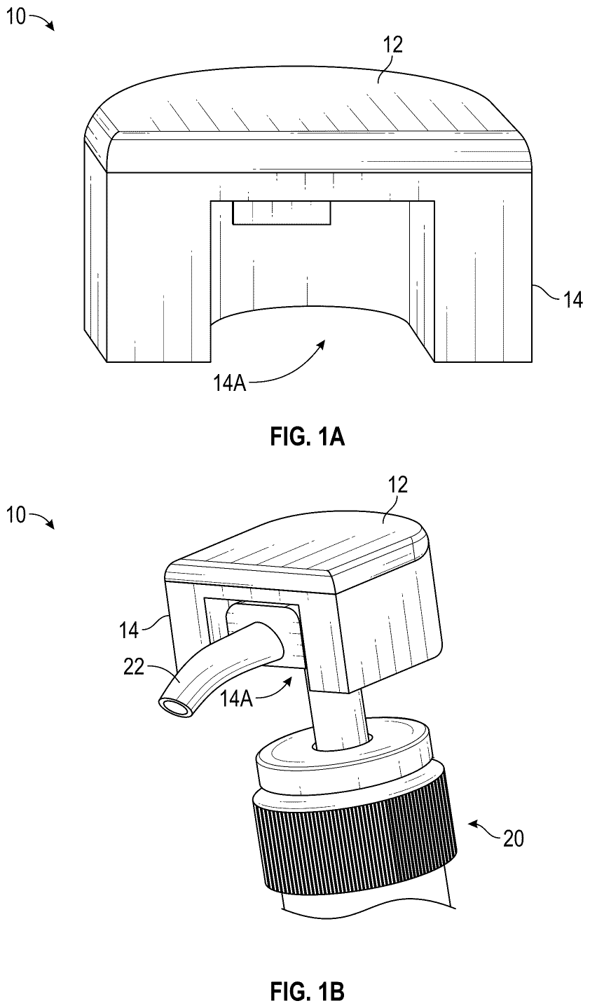

FIGS. 1A and 1B illustrate an indicator 10 according to an embodiment of the present disclosure. The indicator 10 may include a light 12 and a body or base 14. The light 12 can be LEDs, LCD displays, OLED displays and/or any other form of electronic light or display. The base 14 may include a recess 14A. As shown in FIG. 1B, the recess 14A may be shaped or configured to receive and/or removably secure the indicator 10 to a pump head 22 of a container 20. In some embodiments, the recess 14A may be shaped or configured to receive and/or removably secure the indicator 10 to a base of the container 20. Container 20 may be syrup bottle, a powder container, and/or any other container configured to hold and/or dispense a component (i.e., ingredients, modifiers, or enhancers) of a beverage.

In some embodiments, the light 12 may light up to indicate to a user or a barista that the component in the container 20 is included in a beverage order. In some embodiments, the light 12 may light up one or more colors to indicate that multiple pumps of the component in the container 20 are included in a beverage order. In some embodiments, the light 12 may flash, pulse, or change colors to indicate that multiple pumps of the component in the container 20 are included in the beverage order and/or indicate a number of pumps or an amount of the component in the container 20 included in the beverage order. In some embodiments, the light 12 may create a visual display of a number, letter, and/or symbol to indicate and amount or a number of pumps of the component in the container 20 included in the beverage order.

In some embodiments, the light 12 may light up to indicate to the user or the barista an order that the component or ingredient in the container 20 should be added to the beverage. In some embodiments, the light 12 may flash, pulse or change color to indicate the order the component in the container 20 should be added to the beverage. In some embodiments, the light 12 may light up one or more colors to indicate the order that the component in the container 20 should be added to the beverage or a beverage container.

In some embodiments, the indicator 10 can include one or more sensors 16 (schematically illustrated in FIG. 1C). The one or more sensors 16 may be capacitance sensors or any other sensor configured to detect or determine an amount of the component dispensed by the user or the barista. In some embodiments, the one or more sensors 16 may determine or detect when the user or the barista applies a pressure to the pump head 22 and/or the indicator 10 to dispense the component. The indicator 10 may be position on the pump head 22 and/or the container 20 such that when the user or the barista applies a pressure to the pump head 22 to dispense the component, the one or more sensors 16 may detect the pressure and the amount of pressure. In some embodiments, the one or more sensors 16 can transmit a signal to the light 12, a communication module 30 (schematically illustrated in FIG. 1C), and/or a controller 32 (schematically illustrated in FIG. 1C). In some embodiments, once the one or more sensors 16 determine the amount of the component dispensed by the user or the barista is an amount of the component in the beverage order, the light 12 may turn off or power off to indicate to the user or the barista to stop dispensing the component. In some embodiments, once the one or more sensors 16 determine the amount of the component dispensed by the user or the barista is an amount of the component in the beverage order, the light 12 may flash, pulse, and/or change colors to indicate to the user or the barista to stop dispensing the component.

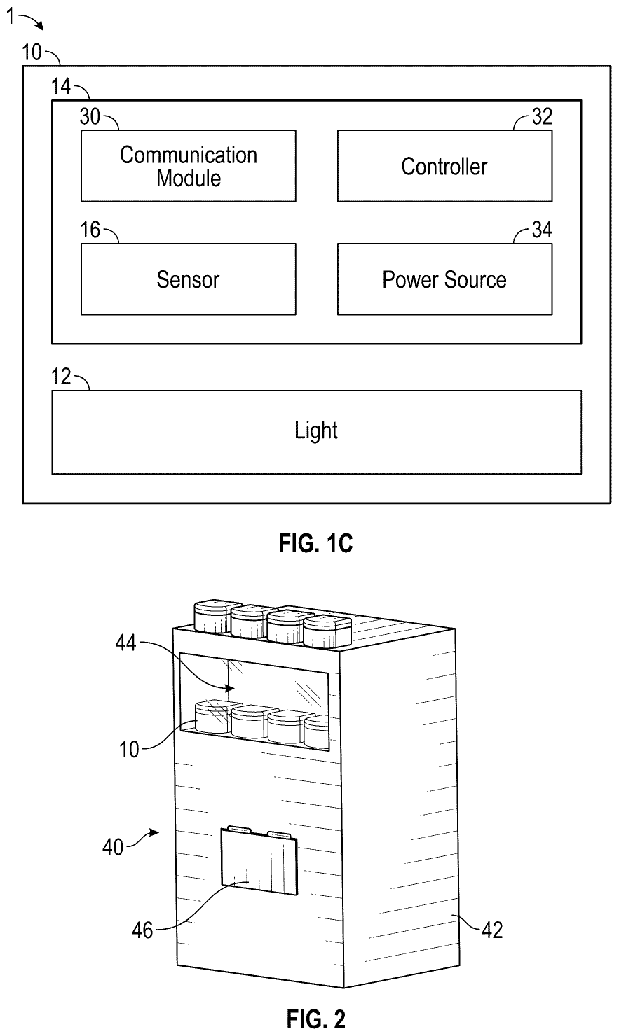

FIG. 1C shows a schematic illustration of a system 1 for beverage component indication for beverage components dispensed from a container 20. The system 1 may include the indicator 10. In some embodiments, the indicator 10 may include a communication module 30, a controller 32, the one or more sensors 16, and/or the light 12. In some embodiments, at least a portion of the control system 1 may be housed or contained in the base 14 of the indicator 10. The communication module 30 may wirelessly or via a wired connection communicate with other indicators 10, a point of sale system and/or a dock device 40 as described below with reference to FIG. 2. In some embodiments, the light 12 may light up, flash or otherwise indicate if the communication module 30 loses connection to other indicators 10, the point of sale system and/or the dock device 40. The controller 32 may control the light 12, the one or more sensors 16, and/or any of the functions of the indicator 10 as described with reference to FIGS. 1A-4. The controller 32 may receive information from the one or more sensors 16 and/or the communication module 30. The controller 32 can use the information to turn on/off the light 12, change a color of the light 12, and/or otherwise control any functions of the light 12 as described with reference to FIGS. 1A-4. In some embodiments, the indicator may include a power source 34. The power source 34 may be a battery (e.g., rechargeable battery or replaceable battery). The power source 34 may supply power to the communication module 30, the controller 32, the one or more sensors, and/or the light 12. In some embodiments, the light 12 may light up a certain color and/or pulse depending on a power level of the power source 34 to indicate to a user or barista that the power level of the power source 34 is full or low. In some embodiments, light 12 may light up a certain color and/or pulse depending on a power level of the power source 34 to indicate to a user or barista that the power level of the power source 34 is above or below a threshold. In some embodiments, the light 12 may display the power level of the power source 34 via a graphic or numerals.

FIG. 2 illustrates an embodiment of a dock device 40. The dock device 40 may include a body 42, and a dock 44. In some embodiments, the body 42 may include a control system (not shown). The control system may perform any functions of the dock device 40 or components of the dock device 40 as described herein. The control system may transmit or receive information or data to/from components of the dock device 40 and/or an indicator 10. In some embodiments, the dock 44 may be an opening or a recess in the body 42 configured to receive one or more indicators 10. The dock 44 can include one or more indicator connectors. In some embodiments the one or more indicator connectors may wirelessly or via a wired connection, connect with the one or more indicators 10. The one or more indicator connectors may wirelessly or via a wired connection, provide power to the power source 34 and/or transmit data signals or information to the one or more indicators 10 via the communication module 30. In some embodiments, the dock device 40 may include a memory configured to store one or more beverage orders, recipes for each of the one or more beverage orders, and/or any other beverage order information.

In some embodiments, the dock device 40 may include an input device 46. In some embodiments, the input device 46 may be positioned on an outer surface of the body 42 and/or a surface of the dock 44. In some embodiments, the input device 46 may be a wireless or wired communication configured to transmit and/or receive information from a point of sale system. In some embodiments, the input device 46 may be a scanner configured to scan a beverage order. The input device 46 may scan a barcode, a QR code, and/or any other computer readable code on the beverage order. In some embodiments, the input device 46 may be configured to scan or read an RFID tag of the beverage order. When the input device 46 scans the beverage order, the input device may receive information or data. Information or data received by the input device 46 may include one or more components of the beverage order, amounts of the one or more components of the beverage order, an order to dispense the one or more components of the beverage order, and/or any other information or data of the beverage order. The dock device 40 may, via a controller, determine one or more indicators 10 to light. The dock device, via the one or more indicator connectors may transmit information to the one or more indicators 10. The information may include instructions for the controllers 32 of the one or more indicators 10. The instructions may communicate to the controllers 32 a color or information to display via the light 12, whether to flash or pulse the light 12, an amount of a corresponding component, an order to dispense the one or more components of the beverage order, and/or any other instructions or data regarding the beverage order.

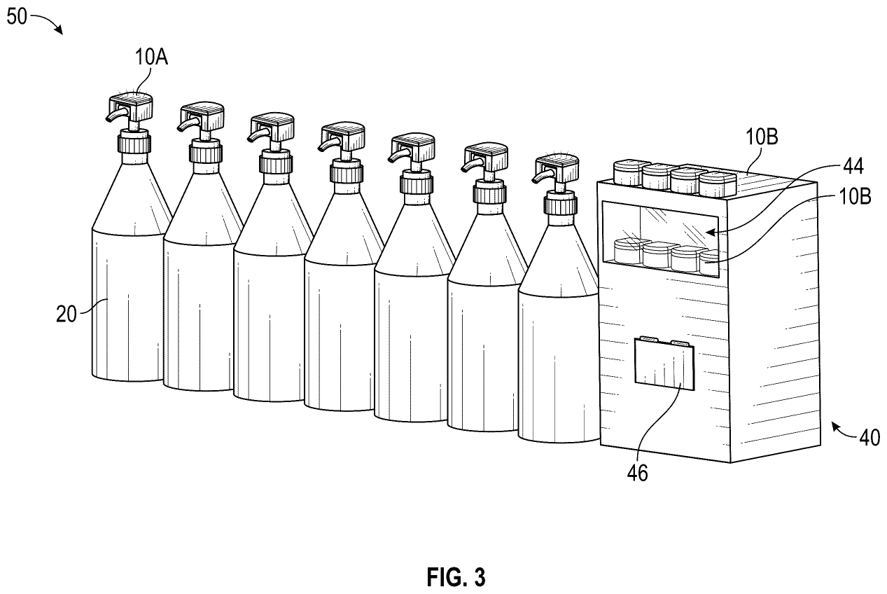

FIG. 3 illustrates an embodiment of a beverage component indication system 50. The beverage component indication system 50 may include a one or more indicators 10 and a dock device 40. The one or more indicators may be paired or connected to the dock device 40 via wired or wireless connection. In some embodiments, the indicators 10 may include a barcode, RFID tag, NFC tag, QR code or any other identifiable information on the indicator 10. The input device 46 of the dock device 40 may scan the identifiable information of each of the one or more indicators 10 to pair or connect the one or more indicators 10 to the dock device 40.

In some embodiments, each of the one or more indicators 10 may be paired with a container 20. The one or more indicators 10 may be paired with a container 20 before or after the one or more indicators 10 are coupled to the container 20. In some embodiments, the communication module 30 may be configured to scan a barcode, RFID tag, NFC tag, QR code or any other identifiable information on the container 20 to pair the indicator 10 with the container 20. In some embodiments, the input device 46 may the barcode, RFID tag, NFC tag, QR code or any other identifiable information on the container 20 to pair the indicator 10 with the container 20. In some embodiments, the dock device 40 may select an indicator 10 to pair with the container 20 or the user or the barista may scan the indicator 10 before or after scanning the container 20 to pair the indicator 10 with the container 20. In some embodiments, the light 12 of an indicator 10 may flash, pulse, change color, and/or otherwise indicate when the indicator 10 is successfully paired with a container 20.

In some embodiments, the indication system 50 may include one or more paired indicators 10A and/or one or more unpaired indicators 10B. The dock device 40 may charge the power source 34 of the unpaired indicators 10B while the one or more paired indicators 10A are in use and coupled to containers. In this way, if the power source 34 of a paired indicator 10A is low on power or runs out of power, the paired indicator 10A can be replaced with an unpaired indicator 10B.

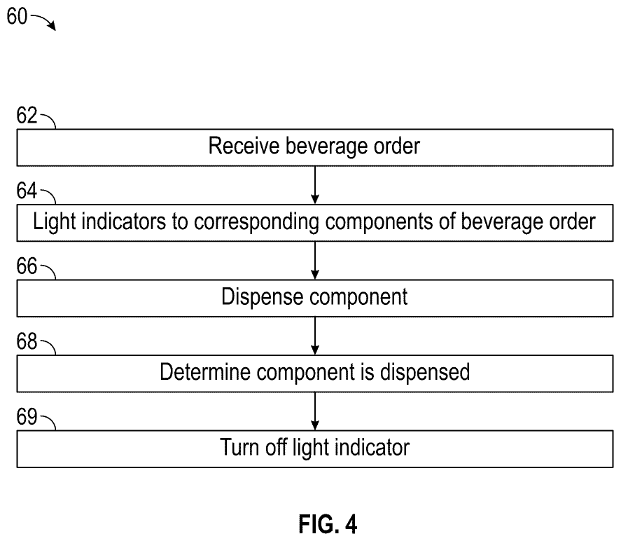

FIG. 4 shows a flowchart of a method 60 of dispensing a beverage using an indication system 50. At step 62 of method 60, the indication system 50 may receive a beverage order including one or more components. The dock device 40 may receive the beverage order by scanning a beverage order, or dock device 40 and/or the one or more indicators 10 may wirelessly or via a wired connection receive the beverage order from a point of sale system.

After the indication system 50 receives the beverage order at step 62, the indication system 50 may light up lights 12 of one or more paired indicators 10A corresponding to containers 20 of each component of the beverage order at step 64. The lights 12 may light up as described with reference FIGS. 1A and 1B. The lights 12 may indicate an order in which the user or barista should dispense each component of the beverage order, and/or an amount or number of pumps of each component of the beverage order. In some embodiments, the indication system 50 may light up lights 12 on all of the one or more paired indicators 10A if the beverage order contains all of the components corresponding to all of the one or more paired indicators 10A. In some embodiments, the indication system 50 may light up a portion of the one or more paired indicators 10A if the beverage order does not contain all of the components corresponding to the one or more paired indicators 10A.

After the indication system 50 lights up lights 12 of one or more paired indicators 10A at step 64, the user or the barista may dispense a component of the beverage order at step 66

After the user or the barista dispenses the component of the beverage order at step 66, the indication system 50 may determine or detect an amount of the component dispensed or if the proper amount of the component has been dispensed by the user. In some embodiments, each time the user or the barista dispenses an amount of the component of the beverage order, the indication system 50 may change a color of the light 12 of the paired indicator 10A, flash or pulse the light 12 of the paired indicator 10A and/or otherwise indicate to the user or barista via the light 12 of the paired indicator 10A an amount of the component dispensed by the user or the barista, or a remaining amount of the component the user or the barista still has to dispense.

If the indication system 50 determines the proper amount of the component has not been dispensed by the user or the barista, the user may repeat step 64, and the indication system 50 may repeat step 66 until the indication system determines the proper amount of the component has been dispensed by the user or the barista.

Once the indication system 50 determines the proper amount of the component has been dispensed by the user or the barista, at step 68, the indication system 50 may turn off light 12 of the paired indicator 10A at step 69.

The user or the barista and/or the indication system 50 may repeat steps 64-68 until all of the components of the beverage order are dispensed by the user or the barista. In some embodiments, the indication system 50 may light up the lights 12 of the one or more paired indicators 10A to indicate to the user or the barista that the beverage order is complete (i.e., all of the components of the beverage order have been dispensed).

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A beverage component indicator, comprising:
a body comprising a sensor and a recess configured to receive a pump head of a corresponding container; and
a light coupled to the body,
wherein the light is configured to light up to indicate when a component in the corresponding container is part of a beverage order, and the sensor is configured to determine when a user dispenses an amount of the component into a beverage container.

2. The beverage component indicator of claim 1, wherein the light is configured to turn off when the sensor determines the amount of the component the user dispenses is an amount of the component in the beverage order.

3. The beverage component indicator of claim 1, wherein the light is configured to indicate when to dispense the component into the beverage container.

4. The beverage component indicator of claim 1, wherein the light is configured to indicate the amount of the component in the beverage order.

5. The beverage component indicator of claim 1, further comprising a controller configured to send information to the sensor and the light, and the controller is configured to receive information from the sensor and the light.

6. The beverage component indicator of claim 1, wherein the sensor is a capacitance sensor.

7. The beverage component indicator of claim 1, wherein the body comprises a power source, and the light is configured to indicate if a power level of the power source is below a threshold.

8. A system for indicating components of a beverage order, comprising:
a plurality of indicators, each of the plurality of indicators comprising:
a body comprising, a communication module, a sensor, and a recess configured to receive a pump head of a corresponding container; and
a light coupled to the body,
wherein the light is configured to light up to indicate when a component in the corresponding container is part of a beverage order, and the sensor is configured to determine when a user dispenses an amount of the component into a beverage container;
a dock device comprising:
a body comprising a control system; and
a dock configured to receive the plurality of indicators;
wherein the control system is configured to transmit information to the communication module of each of the plurality of indicators, and each of the indicators are configured to light up the light of each of the indicators based on the information.

9. The system of claim 8, wherein each of the indicators comprise a power source, and the dock of the dock device comprises an indicator connector configured to supply power to the power source of each of the indicators.

10. The system of claim 8, wherein the dock device comprises a communication module configured to communicate with a point of sale system.

11. The system of claim 10, wherein the communication module is configured to receive beverage orders from the point of sale system.

12. The system of claim 8, wherein the dock device comprises an input device configured to receive a beverage order.

13. The system of claim 8, wherein the information is based on a beverage order.

14. A method of dispensing a beverage, the method comprising:
receiving, by a dock device, a beverage order comprising one or more components;
transmitting, by the dock device, information regarding the beverage order to one or more indicators;
receiving, by each of the one or more indicators, the information;
based on the received information, each of the one or more indicators, turning on a light of each of the one or more indicators if a component of a container paired with the indicator is part of a beverage order;
dispensing, by a user, an amount of a first component of the beverage order;
determining, by a sensor of a first indicator, the amount of the first component dispensed by the user, wherein the first indicator is an indicator paired to a container of the first component; and
turning off, by the first indicator, the light of the first indicator paired with the container of the first component when the amount of the first component dispensed by the user.

15. The method of claim 14, further comprising:
dispensing, by the user, an amount of a second component of the beverage order;
determining, by a sensor of a second indicator, the amount of the second component dispensed by the user, wherein the second indicator is an indicator paired to a container of the second component; and
turning off, by the first indicator, the light of the first indicator paired with the container of the first component when the amount of the first component dispensed by the user.

16. The method of claim 14, wherein the lights of the one or more indicators are configured to indicate an order to dispense the one or more components of the beverage order.

17. The method of claim 14, wherein each container is paired with each indicator by scanning identifiable information of each container and identifiable information of each indicator.

18. The method of claim 14, wherein the sensor of the first indicator detects a pressure applied to a pump head of the container to determine the amount of the first component dispensed by the user.
